(19) United States
(12) Patent Application Publication
(10) Pub. No.: US 2007/0013096 A1
(43) Pub. Date: Jan. 18, 2007

(54) Multistage method and apparatus for continuously forming a composite article

(76) Inventor: Andrew Rekret, Toronto (CA)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/487,218

(22) Filed: Jul. 14, 2006

Related U.S. Application Data
(60) Provisional application No. 60/699,465, filed on Jul. 15, 2005.

(30) Foreign Application Priority Data
Mar. 8, 2006 (CA) 2,538,917

(51) Int. Cl. B32B 27/00

(52) U.S. Cl. 264/45.5; 428/318.4; 428/319.3; 425/588

(57) ABSTRACT

There is disclosed a multistage molding apparatus and method for continuously forming a composite article. The apparatus comprises a first stage for forming a skin, a second stage for applying a structural foam to the skin as the skin is being cured to form the composite article and a third stage for curing the composite article. The method comprises the steps of impregnating a skin forming material with a first resin at a first stage, curing the skin forming material to form a skin, while applying a foam to the impregnated skin forming material before the impregnated skin forming material is fully cured in a second stage, and curing the foamed skin to form the composite article at a third stage. There is also disclosed a composite article comprising a skin layer bonded to a foam layer.

### FIELD OF THE INVENTION

This invention relates to an apparatus and method for making molded plastic articles. More particularly, this invention pertains to a method and apparatus for making composite plastic molded articles, and composite articles so made.

### BACKGROUND OF THE INVENTION

Plastic molding is a well-known technique for mass manufacturing articles simply and inexpensively. As advances in molding technologies are made plastic components are being used in ever more numerous applications, replacing other materials such as metal and wood. However, to be able to replace such materials requires the use of advanced techniques to enhance the strength and stability of the plastic molded articles. One such technique is to use a composite structure for the molded article.

For example U.S. Pat. No. 6,863,972, discloses a composite panel having a synthetic wood layer that is secured to a foamed polymer layer. However, this patent teaches using a cellulosic filler material in an amount of about 20% to 70% by weight in the synthetic wood layer, to give it the look and feel of wood. However, such filler material is somewhat weak and reduces the strength of the synthetic wood layer, meaning the size of the composite component needs to be quite large to support loads.

Stronger and higher load bearing and thinner layers can be made with fiberglass or carbon reinforced plastic layers. A preferred method of making such articles is through the pultrusion process.

In a typical pultrusion process a fibrous mat or braid is fed into an injection die, where it is passed over a mandrel and is impregnated under pressure with a resin. From there, the resin impregnated braid is passed to a pultrusion die with a mandrel for forming heating and then pulling the cured reinforced layer from the die for finishing. An example of a pultrusion process for forming a hollow tube is shown in U.S. Pat. No. 6,395,210. One problem with pultrusion of hollow structures is that the cured reinforced layer must still be thick enough to provide the structural integrity necessary to withstand the forces of the pulling mechanism.

Attempts have been made to combine the pultrusion process with a foam core to manufacture composite panels. However, it can be very difficult to bond the foam to the pultruded layer. For example, U.S. Pat. No. 5,286,320 discloses pultruding composite panels using pre-formed foam core board. Reinforcements, such as glass fiber mats and continuous fibers are added to the outside surfaces of the foam core board as it passes through a pre-forming die. Next the foam core board and fiber reinforcements are pulled through a pultrusion die where the liquid resin is applied and cured to form a fiber-reinforced layer.

To help to make a better bond the patent teaches that the foam core board must have foam cells containing water or other vaporizable material. In the heated die the water vaporises, causing the foam to expand thereby pressing the foam against the reinforced layer. This in turn forces the reinforced layer against the inner surface of the die, leading to a smoother outer finished surface. However, rigid structural closed cell foams are not capable of being expanded by such a process and so the teachings of this patent are not suitable for such foams, and yet such foams are highly desirable in structural components.

What is desired is a simple, cost efficient molding apparatus and method that can be used to pultrude a fibre reinforced layer having a three-dimensional profile onto which a structural foam has been securely and structurally bonded. Such an article will be a light weight and inexpensive substitute for other types materials in many applications.

### SUMMARY OF THE INVENTION

One aspect of the present invention is to provide a multistage molding apparatus for continuously forming a composite article, said apparatus comprising: a first stage for forming a skin, a second stage for applying a structural foam to said skin as said skin is being cured to form said composite article and a third stage for curing said composite article.

In another aspect, the first stage comprises an injection die and a spaced apart mandrel to define an injection die cavity therebetween sized and shaped to continuously receive a skin forming material at one end of said injection die cavity, said first stage further including a resin pump to inject a resin into said skin forming material in said injection die cavity as said skin forming material passes through said injection die.

In yet another aspect, the first stage further includes a means to remove excess resin from said injection die cavity and skin forming material as said skin forming material passes through said injection die. In a further aspect, said means to remove excess resin permits said excess resin to be reused in said injection die. In yet a further aspect, the first stage further includes a means to remove air or any form of gas from said excess resin.

In another aspect, the second stage includes a pultrusion die, downstream of said first stage, to cure said skin forming material and said resin to form said skin.

In another aspect, the third stage includes a curing die to complete the curing of said foam and skin composite article.

In another aspect, the apparatus further comprises a fourth stage for applying a coating to an outside surface of said composite article. In a further aspect, the fourth stage includes a coating applicator for smoothly coating said composite article with said coating. In yet a further aspect, said coating applicator applies a photocuring coating and said fourth stage further includes a light source for curing said coating.

In another aspect of the present invention, there is provided a multistage method for continuously forming a composite article, said method comprising the steps of:
impregnating a skin forming material with a resin at a first stage;
curing said impregnated skin forming material to form a skin, while applying a foam to said impregnated skin forming material before said impregnated skin forming material is fully cured in a second stage; and
curing said foamed skin to form said composite article at a third stage.

In another aspect the method provides that the resin is made from a first composition and said foam is made from a second composition, wherein said first and second compositions have a sufficient amount of a common ingredient to permit said first and second compositions to bond to one another. In a further aspect, the common ingredient is a type of thermoplastic resin, one example being ABS plastic.

In another aspect, the method further includes a step of coating said composite article with a finish coat.

In another aspect, there is provided a composite article comprising:
a skin layer bonded to a foam layer,
wherein said skin layer is made from a first composition and said foam layer is made from a second composition, and wherein said first and second compositions have a sufficient amount of a common ingredient to permit said first and second compositions to bond to one another.

In a further aspect, said common ingredient is a type of thermoplastic. In yet a further aspect, said thermoplastic is ABS plastic.

In another aspect, said composite article further comprising a finish coat layer bonded to said skin layer. In a further aspect, said finish coat layer is a type of photocured finish coat material.

### BRIEF DESCRIPTION OF THE DRAWINGS

Reference will now be made to the preferred embodiments of the present invention with reference, by way of example only, to the following drawings in which:

FIG. 1 is a schematic diagram of a cross-section of the present invention in operation and showing a first stage for forming a skin, a second stage for applying a structural foam to said skin as said skin is being cured to form a composite article and a third stage for curing said composite article;

FIG. 2 is a schematic diagram of a cross-section of the invention of FIG. 1, showing the injection die of the first stage;

FIG. 3 is a schematic diagram of a cross-section of the invention of FIG. 1, showing the pultrusion die of the second stage;

FIG. 4 is an alternate embodiment of the second stage of FIG. 3 showing vacuum channels for helping to hold the skin against the interior surfaces of the pultrusion die;

FIG. 5 is a schematic diagram of a cross-sectional view of the invention of FIG. 1 showing a coating applicator of a fourth stage for applying a coating to a bottom outside surface of the composite article;

FIG. 6 is a schematic diagram of a cross-sectional view of the invention of FIG. 5 showing an alternate embodiment of the coating applicator capable of applying the coating to a top and bottom outside surfaces of the composite article;

FIG. 7A is a side view of a composite article according to an embodiment of the present invention in which the foam layer is sandwiched between two skin layers;

FIG. 7B is a side view of the composite article of FIG. 7A with a coating applied to the outside surfaces of both skins;

FIG. 7C is a side view of a composite article according to an embodiment of the present invention in which the foam layer is bonded to a skin layer; and

FIG. 7D is a side view of the composite article of FIG. 7C with a coating applied to the outside surface of the skin.

### DETAILED DESCRIPTION OF THE PREFERRED EMBODIMENTS

The present invention is described in more detail with reference to exemplary embodiments thereof as shown in the appended drawings. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein. In the figures, like elements are given like reference numbers. For the purposes of clarity, not every component is labelled in every figure, nor is every component of each embodiment of the invention shown where illustration is not necessary to allow those of ordinary skill in the art to understand the invention.

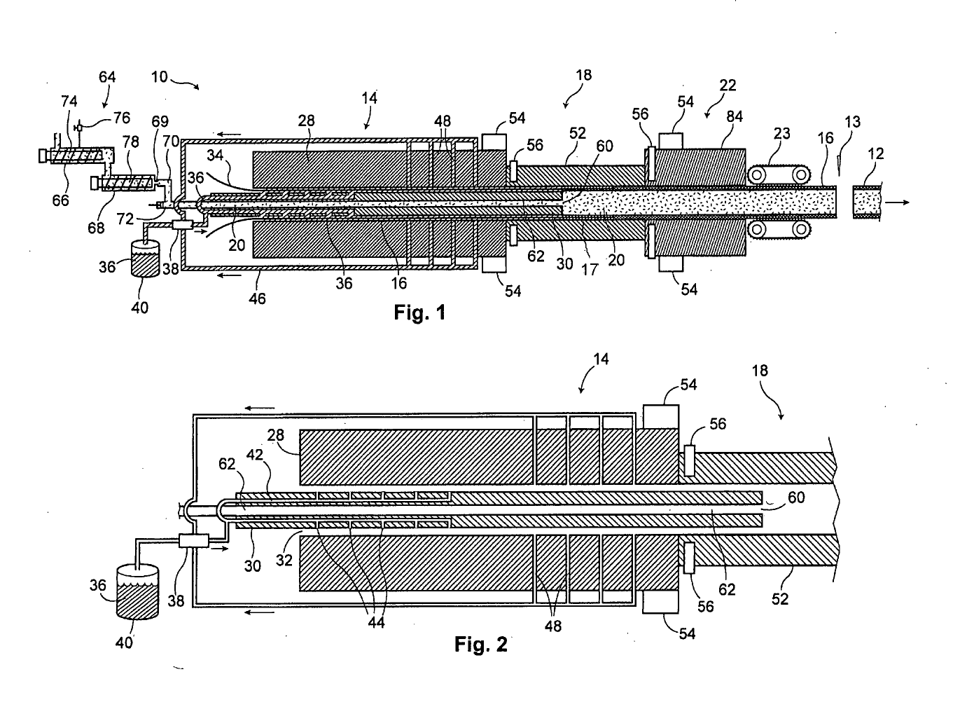

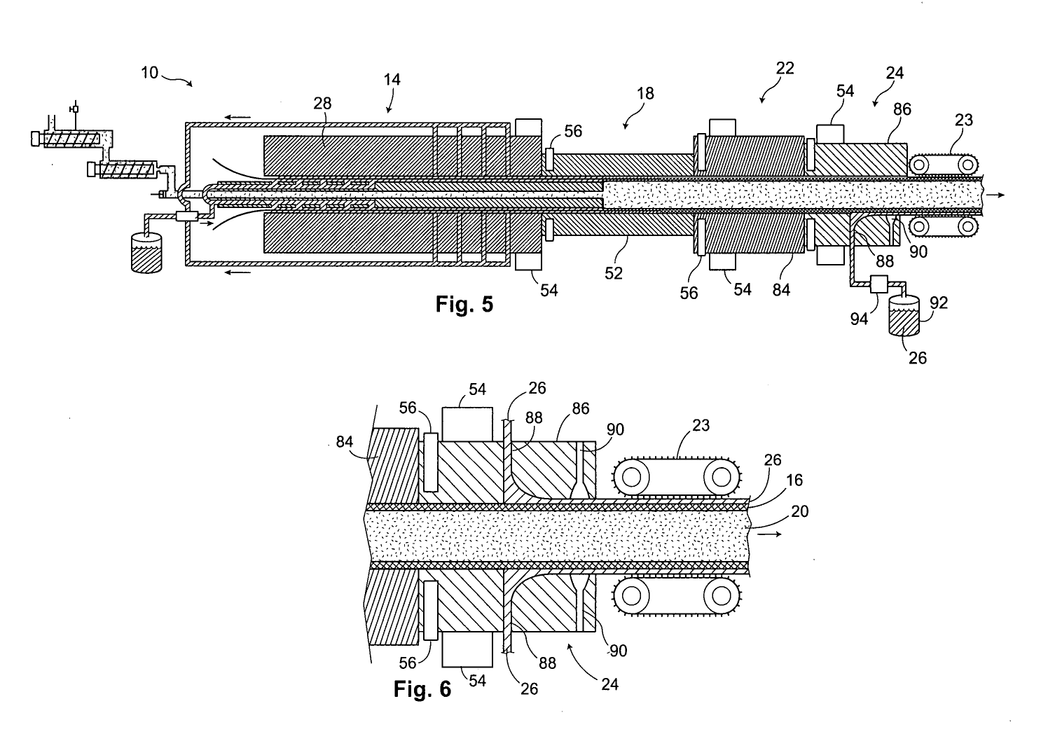

A multistage molding apparatus 10 for continuously forming a composite article 12 according to the present invention is disclosed in FIG. 1. The first stage 14 involves forming a skin 16, the second stage 18 involves applying a structural foam 20 to the skin 16 as the skin 16 is being cured (indicated at 17), and the third stage 22 involves curing the skin 16 and foam 20 of the composite article 12. A pulling mechanism 23 located at the downstream end of the apparatus 10 is used to pull a skin forming material 34 through the apparatus 10 at a predetermined rate. FIGS. 5 and 6 show a fourth stage 24 which involves applying a gel coat or finish coat 26 to the composite article 12. A key aspect of the present invention is that the multistage molding apparatus 10 allows for a continuous flow-through manufacture of a finished composite article 12 without the need for handling or other manipulation between stages. The endless composite product produced in this way is cut to size by a cutter 13 and then finished after exiting the apparatus 10. The finished composite article 12 is then ready for packaging and shipping.

Referring to FIG. 2, there is shown a schematic diagram of the first stage 14. The first stage comprises an injection die 28 and a spaced apart mandrel 30 to define an injection die cavity 32 therebetween. The injection die 28 may be made by any means known in the art, out of any suitable heat conducting material having the requisite structural integrity. Aluminium is a preferred material, but steel may also be used. The injection die cavity 32 is sized and shaped to continuously receive a skin forming material 34 at one end of the injection die cavity 32, and discharge it at the downstream end, after it has been impregnated with a resin 36. The skin forming material 34 is shaped by the injection die cavity 32 while being impregnated with the resin 36 as it passes through the injection die cavity 32. The injection die 28 may be configured to form the skin forming material 34 into profiles ranging from a simple two-dimensional sheet to a complex three-dimensional a hollow member.

In a preferred embodiment the resin 36 is pumped into the injection die cavity 32 by a resin pump 38 under pressure. The resin pump 38 forces the resin 36 from a reservoir 40 into channels 42 located in the upstream end of the mandrel 30 which terminate in a series of injection ports 44 for injecting the resin 36 into the injection die cavity 32. However, other means for injecting resin 36 into the injection die cavity 32 are also contemplated, such as for example, by injecting the resin 36 directly into the injection die cavity 32 through channels (not shown) in the upstream end of the injection die 28 itself. What is important is that the skin forming material 34 is impregnated with sufficient resin 36 as it passes through the injection die 28 to create a reinforced layer having the desired structural properties for the specific application.

If the resin 36 is of the type that is formed from two or more components which must be mixed before use, the components may be provided in separate reservoirs 40 which are mixed in an appropriate ratio by the resin pump 38, or by a mixer (not shown) provided before the resin pump 38.

While the injection die 28 is disclosed herein as the first stage 14 of the multistage molding apparatus 10, it is contemplated that the injection die 28 may be used separately in other applications.

Suitable materials for use as the skin forming material 34 are well known in the art, and can be selected from a wide variety of materials, such as glass-reinforcing fibres, or such other fibres as may be suitable for the desired purpose. Continuous length fibers in the form of roving or mats are preferred. What is desired is to use fibres that will retain their strength and integrity during the temperature ranges which occur during the various stages of the instant invention. In particular, the fibers must be able to withstand the pulling forces and temperatures that are during the various stages of the instant invention.

Suitable resins useful for impregnating the skin forming material 34 are also well-known. For example, the resin 36 may be a thermoset resin such as unsaturated polyesters, epoxies, phenolics, methacrylates and the like, as well as thermoplastic resins such as PP, PU, PPS, ABS, and Nylon 6.

In one embodiment of the present invention the injection die 28 includes a means for removing excess resin 46 from the injection die cavity 32 and skin forming material 34 as the skin forming material 34 passes therethrough. This is accomplished via resin removal channels 48 located near the downstream end of the injection die 28. The resin removal channels 48 provide a pathway for the excess resin 46 to flow from the injection die cavity 32 to the outside of the injection die 28 and connect to the resin pump 38. It will be noted that the excess resin 46 is removed from the injection die 28 without being exposed to the atmosphere and so is not likely to become contaminated with dust, dirt or the like. In addition, the resin removal channels 48 are located sufficiently remote from the injection ports 44 so as to avoid short circuiting of the resin 36. In other words, the resin removal channels 48 are sized and positioned so as to create a pressure drop between said injection ports 44 and said removal channels 48 which is larger than the desired injection pressure for said resin 36 in said die 28, so said resin 36 fully impregnates said skin forming material 34.

The removed, excess resin 46 may be reused by being re-injected into the injection die cavity 32. Prior to being reused, however, any entrained air or other gases are removed from the excess resin 46 before it is redirected back into the injection die cavity 32. Any such entrained air or gases could lead to bubbles or blisters in the finished product and are thus undesirable. The air is most preferably removed by providing a separate settling tank (not shown), or providing a settling chamber (not shown) in the resin pump 38, which allows entrained air or other gaseous bubbles to rise to the surface and break before the excess resin 46 is redirected back into the injection die cavity 32 and reused. In addition to helping to minimize the amount of resin 36 that is wasted in the first stage 14, the resin removal channels 48 also help to eliminate air trapped in the resin impregnated skin forming material 34, which helps to minimize the production of voids and maximize resin impregnation of the skin forming material 34. The resin recirculation system disclosed is a closed system, which, in addition to the benefits mentioned above permits complete temperature control of the resin path wherein the resin is not allowed to undergo temperatures which would affect its ability to be reused.

As will be appreciated by those skilled in the art, the temperature of the injection die 28 must be carefully controlled and maintained below a temperature that would lead to the curing of the resin 36. It is also well-known that the length of the injection die 28 is determined with a goal of providing maximum penetration of resin 36 into the skin forming material 34, ensuring a very good wet out without trapping air or off gas. This is contrasted with the competing goal of keeping the injection die 28 as short as possible to reduce the pull force required and increase the production speed. Good results have been achieved with an injection die 28 having a length of about 24 inches.

As shown in FIG. 1, the second stage 18 comprises a pultrusion die 52 which is connected to the downstream end of the injection die 28. The second stage 18 involves applying a structural foam 20 to the skin 16 as the skin 16 is being cured. The temperatures required to cure the skin 16 are typically much higher than those desired to wet the skin forming material 34 in the first stage 14. Accordingly, a means for controlling the temperature of the injection die 28 is preferably included at the downstream end of the injection die 28.

As shown in FIG. 2, the means for controlling the temperature, in the present embodiment, is a cooler 54 contacting the outside surfaces of the injection die 28. However, various coolers and other means for controlling the temperature of the injection die 28 will be known to those skilled in the art and are not described in any great detail herein. Some preferred examples of coolers comprehended by the present invention include, water cooling, refrigerating coils, thermal breaks including heat conducting fins, or ceramics, etc. A thermal break 56 having heat conducting fins, or ceramics or the like is preferred on the upstream end of the pultrusion die 52. As a higher heat is required in the pultrusion die 52, to cure the skin 16, than is required in the injection die 28 of the first stage 14, the thermal break 56 limits the rise in the temperature of the injection die 28. Most preferably such a rise is limited to an amount below the curing initiation temperature of the resin 36. As can be appreciated a temperature rise in the injection die 28 above the curing initiation temperature of the resin 36 would result in the premature curing of the resin 36, before the skin forming material 34 has had adequate opportunity to become impregnated with the resin 36.

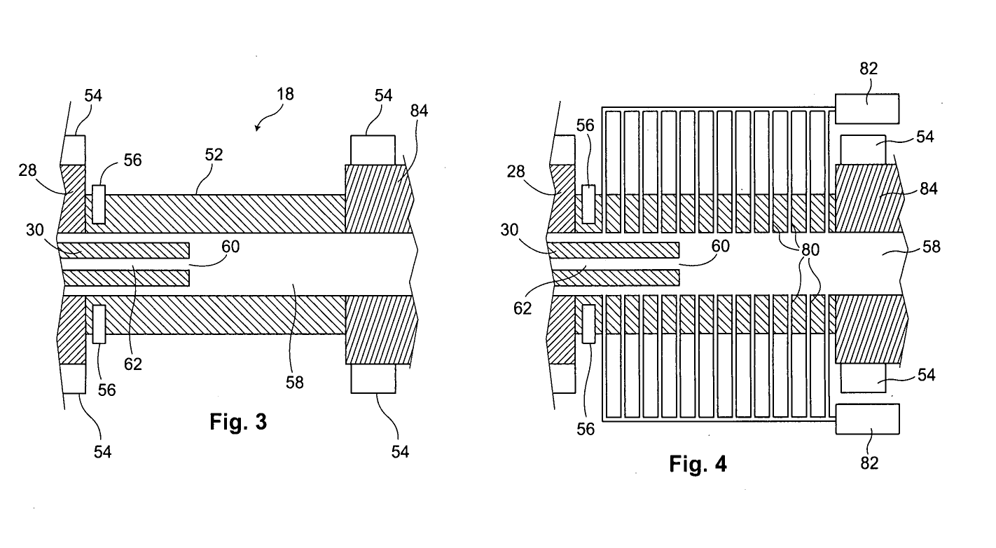

As shown, FIG. 3, the pultrusion die 52 is involved in the second stage 18 to apply the structural foam 20 to the skin 16 and to cure the skin 16 and foam 20 to form the composite article 12 as it passes therethrough. As will be appreciated by those skilled in the art, the length of the pultrusion die 52 depends on many factors such as wall thickness, expected speed of production, expected quality of surface finish, etc. The length of the pultrusion die 52 also depends on the time required to bring the resin impregnated skin forming material 34 to the curing temperature, which is typically about 400° F. However, a competing factor is that a longer pultrusion die 52 increases the pull force that is required by the pulling mechanism 23. Moreover, proper temperature distribution allows for an increased speed of pultrusion. Good results have been obtained with pultrusion dies 52 having lengths of between about 12 to about 18 inches. As will be appreciated, by persons skilled in the art, this is significantly shorter than known pultrusion dies. Due to their shorter length, the pultrusion dies utilized by the present invention are fast, easy and cost-efficient to fabricate. For example, the pultrusion dies of the present invention may be fabricated using an axial cutting method, such as wire cutting, to prepare a tube shaped die, as opposed to having to cut the die in half and using milling or grinding to define separately each half of the profile in each die part. The reason that the multistage apparatus 10 of the present invention permits the use of shorter than traditional pultrusion dies is that curing of the skin 16 continues in the adjacent and downstream second stage 18 and third stage 22.

Referring still to FIG. 3, the mandrel 30 is shown as extending from the injection die 28 and most preferably part way into the pultrusion die cavity 58. The amount by which the mandrel 30 extends into the pultrusion die cavity 58 is governed by three considerations. First, it is important that the mandrel 30 extends to a point into the pultrusion die cavity 58 where the skin 16 has not fully cured. At this point the skin 16 will need to have cured sufficiently to have structural integrity to withstand the forces exerted by the foam 20 which are sufficient to keep the skin 16 pressed against the surfaces of the pultrusion die cavity 58. The force of the foam 20 is sufficient that the skins no longer need to be supported by the mandrel 30. Second, it is important that the foam 20 is applied to the skin 16, before the skin 16 has fully cured. This ensures a strong molecular bond will be formed between the skin 16 and the foam 20, in the finished composite article 12. Third, it is desirable to have the mandrel 30 as short as possible, to reduce the pull force that is required by the pulling mechanism 23. Accordingly, it is preferred that the mandrel 30 extend into the pultrusion die cavity 58 by the shortest possible amount which will allow the foam 20 to be applied to a still curing skin 16. Good results have been obtained with the mandrel 30 extending into the pultrusion die cavity 58 by about 4 and 6 inches.

FIG. 4 shows an alternate embodiment of the pultrusion die 52 of the present invention. As shown, there is a plurality of vacuum channels 80 included in the pultrusion die 52, leading from the pultrusion die cavity 58 to the vacuum pump 82. The purpose of these vacuum channels 80 is to draw the skin 16 against the surfaces of the pultrusion die cavity 58. This configuration is useful when forming composite articles 12 in which the foam layer is very thin, by helping to keep the skin 16 layers conforming to the die shape during the curing stages. This alternate embodiment is also useful when using a thermoplastic resin 36 to impregnate the skin forming material 34.

With reference to FIGS. 1, 3 and 4, it will be apparent that the structural foam 20 is delivered into the pultrusion die cavity 58 through a foam injector 60 located on the mandrel 30. If the skin 16 is formed in the injection die 28 as a hollow member, the foam injector 60 places the foam 20 inside of the hollow member. In other cases, the foam injector 60 injects the foam 20 into the pultrusion die cavity 58 so as to apply the foam 20 to the surfaces of the skin 16.

The foam 20 is delivered to the foam injector 60 via one or more foam delivery conduits 62 located in the mandrel 30. As best seen in FIG. 1, the upstream end of the foam delivery conduit 62 is connected to a means for preparing the structural foam 20, which is referred to herein as a foamer 64.

The structural foam 20 prepared by the foamer 64 is preferably a rapidly curing, closed cell, microcellular thermoplastic foam material capable of bonding to the skin 16, as the skin 16 and the foam 20 are curing. Thermoplastic foam material, such as polystyrene, is preferred to thermoset foam material because the latter will expand further during the third stage 22 and contact the skin 16 under pressure, to help eliminate voids between the foam 20 and the skin 16. Microcellular plastics are characterized by cell sizes in the range of 0.1 to 10 micrometers, cell densities in the range of 109 to 1015 cells per cubic centimeter, and specific density reductions in the range of 5% to 95%. What is important is to create a large number of bubbles, smaller than the pre-existing flaws in the foam layer 20. Microcellular thermoplastic foam is preferred to unfoamed plastic because it exhibits up to a five-fold increase in Chirpy impact strength, toughness, stiffness-to-weight ratio, and fatigue life. Furthermore, microcellular thermoplastic foam exhibits high thermal stability, low dielectric constant and low thermal conductivity. As will be appreciated by those skilled in the art, the thermoplastic materials, as well as other parameters used to make the microcellular foam will vary depending on the foam characteristics that are required in a particular application. However, one important characteristic of the foam is that it should have cell sizes as small as possible.

The foamer 64 used to produce the foam 20 has a first mixing chamber 66, connected to a second mixing chamber 68, a temperature and pressure controlled reservoir 70 and a foam pump 72. In order to prepare the closed cell, microcellular foam, thermoplastic material is melted and mixed in the first mixing chamber 66 with an agitator 74. Air is injected into the first mixing chamber 66 by an air injection means 76 to entrain air in the thermoplastic material under pressure. Once the molten, air entrained, thermoplastic material has been thoroughly mixed, it is moved into the second mixing chamber 68 which has a mixer 78 and temperature control to permit the thermoplastic material to be further mixed and cooled under pressure. The second mixing chamber 68 is connected to an outlet 69 for expelling the thermoplastic material from the second mixing chamber 68 at a lower pressure than is maintained in the chamber 68 into the temperature and pressure controlled reservoir 70.

The finished foam 20 is then injected from the reservoir 70 into the foam delivery conduit 62 by the foam pump 72. The foam pump 72 may be a piston or screw type pump. What is important is that the rate and pressure with which the foam 20 is delivered to the foam delivery conduit 62, and into the pultrusion die cavity 58 may be controlled. The present invention comprehends maintaining the foam at a higher pressure within the foam injection conduit than within the space adjacent to the skin. The pressure drop needs to be sufficient to cause the foam to expand as it enters into contact with the skin. This expansion then provides the necessary pressure to permit good bonding to occur according to the present invention. The actual pressure drop will vary depending upon the product. The pressure drop required to maintain the good foam to skin bonding will vary depending upon the thickness of the foam layer, the speed of production, the type of foam used and the like.

Continuing to refer to FIG. 1, the third stage 22 of the multistage molding apparatus 10 is shown to follow downstream of the second stage 18. The third stage 22 includes a curing die 84 to complete the curing of the skin 16 and foam 20 of the composite article 12. Since the curing die 84 is typically maintained at a cooler temperature than the pultrusion die 52, the curing die 84 needs to be thermally isolated from the second stage 18, in order to permit the controlled curing of the composite article 12. According to one embodiment, thermal isolation is achieved with a thermal break 56 at the upstream end of the curing die 84. A cooler 54 may also be provided at the upstream end of the curing die 84, to help maintain the required temperature. Such thermal breaks 52 and coolers 54 of various types, as well as other means for controlling the temperature of the curing die 84 are well known to those skilled in the art. Without limitation, some examples of coolers 54 include, water cooling, refrigerating coils, etc. Some examples of thermal breaks include heat conducting fins, ceramics or the like. What is important is that the very hot temperatures required, to cure the skin 16 in the pultrusion die 52, do not affect the temperature of the curing die 84.

FIG. 5 shows an optional fourth stage 24 which may be provided to the multistage molding apparatus 10 downstream of the third stage 22. The fourth stage 24 is for applying a coating 26 to the outside surfaces of the composite article 12. The fourth stage 24 includes a coating applicator 86 which smoothly coats the composite article 12 with the coating 26. The coating applicator 86 shown in FIG. 5 has one coating dispenser 88 for applying a coating to the bottom of the composite article 12. As shown in FIG. 6, the coating applicator 86 has two coating dispenser 88 for applying the coating 26 to the top and bottom outside surfaces of the composite article 12 and a light source 90 positioned downstream of the coating dispenser 88. It is contemplated that more than one coating dispensers 88 may be provided in the coating applicator 86 for applying the same or a different coating 26 to different parts of the composite article 12. The coating 26 is delivered to the coating dispenser 88 from a coating reservoir 92 under pressure by a coating pump 94. According to a preferred embodiment of the present invention, a photo-curing coating 26 is applied to the outside surface of the composite article 12 through the coating dispenser 88 which is cured as it passes by the light source 90. The light source 90 may be any light source 90 that is required to cure the photo-curing coating 26 being used, such as for example a UV light source. Resin supplied by, for example, BASF® has been found to provide adequate results.

Furthermore, the coating applicator 86 may also be maintained at a higher or lower temperature than the curing die 84. In order to maintain a different temperature, the coating applicator 86 is thermally isolated from the third stage 22 with a thermal break 56 at the upstream end, as shown in FIG. 6. A cooler 54 may also be provided at the upstream end of the coating applicator 86, to help maintain the required temperature. What is important is that the temperature in the curing die 84, in the third stage 22, does not affect the temperature of the coating applicator 86.

While the coating applicator 86 is disclosed herein attached to the curing die 84 as a part of the multistage molding apparatus 10, it is contemplated that the coating applicator 86 may be used separately in other applications.

It can now be understood that the multistage molding apparatus 10 allows for continuously forming a composite article 12 by continuously carrying out three processing steps. The first step involves impregnating a skin forming material 34 with a resin 36 at a first stage 14. The next step involves curing the impregnated skin forming material 34 to form a skin 16, while applying a foam 20 to the impregnated skin forming material 34 before the impregnated skin forming material 34 is fully cured in a second stage 18. The next step involves curing the foamed skin to form the composite article 12 at a third stage 22. In an optional fourth stage 24 a finish coat 26 is applied to the composite article 12. The coating step is preferably done using a photocuring finish coating material, which is cured by the application of UV energy. By the time the continuously formed composite article 12 reaches the pulling mechanism 23 it will be sufficiently cured, so as not to collapse under the pressures exerted by the pulling mechanism 23 within the grip region, even with the skins 16 as thin as 0.50 mm.

Providing a sufficient amount of the same material in each of the resin 36 and the foam 20 permits the foam 20 to bond to the impregnated skin forming material 34, as the impregnated skin forming material 34 is curing in the second stage 22. Good results have been obtained using thermoplastic resin as the common material, such as for example ABS. Preferably, the common ingredient is provided in both of the foam 20 and the skin 16 in a concentration of about seven percent by weight or more. Most preferably, the common ingredient is provided in both the foam 20 and the skin 16 in a concentration of between about three percent and about seven percent by weight.

The molecular bond between the foam 20 and skin 16 is preferred to a chemical bond, such as one achieved with adhesive for at least two reasons. The first is that an adhesive bond requires an additional processing step of applying the adhesive, which entails optimization and control over several further parameters including the amount of adhesive to use, which adhesive to use, how long to allow the adhesive to cure etc. On the other hand, the molecular bond is controlled with temperature. The second reason is that, the characteristics of a molecularly bonded composite article 12 are more predictable than the characteristics of a chemically bonded composite article. Lastly, the molecular bond provides an adequate strength bond between the structural foam and the skin to support considerable loads.

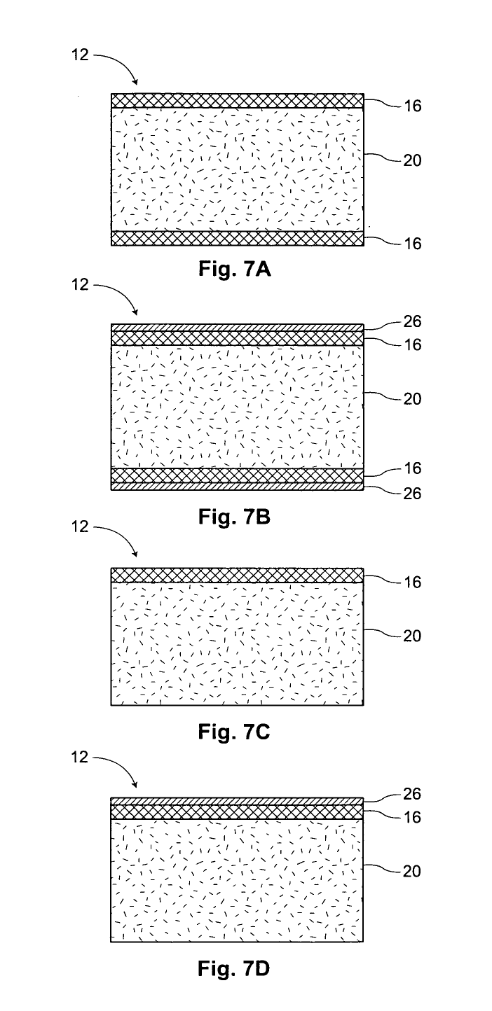

As shown in FIGS. 7A and 7C, the composite article 12 may be formed with a foam layer 20 bonded between two skin layers 16 as a sandwich structure, or with a skin layer 16 bonded only to one foam layer 20. The finish coating 26 may be applied to the skins as shown in FIGS. 7B and 7D. Composite articles 12 formed as a sandwich of a foam layer 20 bonded between two skins 16 as shown in FIGS. 7A and 7B are about 40 times stronger than the foam layer 20 on its own.

Many different uses can be made of the composite articles 12 formed by the present invention. In particular, the composite articles are suitable for panels, window lineals, floors, decks, roofs, sound proof walls, highway barriers, sign boards, telephone and light poles, as well as other applications where cost, strength and weight are factors. Composite articles 12 having complex shaped profiles are possible.

While reference has been made to various preferred embodiments of the invention other variations are comprehended by the broad scope of the appended claims. Some of these have been discussed in detail in this specification and others will be apparent to those skilled in the art. All such variations and alterations are comprehended by this specification are intended to be covered, without limitation.

The embodiments of the invention in which an exclusive property or privilege is claimed are defined as follows:

1. A multistage molding apparatus for continuously forming a composite article, said apparatus comprising: a first stage for forming a skin, a second stage for applying a structural foam to said skin as said skin is being cured to form said composite article and a third stage for curing said composite article.

2. A multistage molding apparatus for continuously forming a composite article as claimed in claim 1, wherein said first stage comprises an injection die and a spaced apart mandrel to define an injection die cavity therebetween sized and shaped to continuously receive a skin forming material at one end of said injection die cavity, said first stage further including a resin pump to inject a resin into said skin forming material in said injection die cavity as said skin forming material passes through said injection die.

3. A multistage molding apparatus for continuously forming a composite article as claimed in claim 2 wherein said first stage further includes a means to remove excess resin from said injection die cavity and skin forming material as said skin forming material passes through said injection die.

4. A multistage molding apparatus for continuously forming a composite article as claimed in claim 3 wherein said means to remove said excess resin permits said excess resin to be reused in said injection die.

5. A multistage molding apparatus for continuously forming a composite article as claimed in claim 4 wherein said first stage further includes a means to remove entrained air or any form of gas from said excess resin.

6. A multistage molding apparatus for continuously forming a composite article as claimed in claim 1 wherein said injection die further includes a means for controlling a temperature of said die.

7. A multistage molding apparatus for continuously forming a composite article as claimed in claim 6 wherein said means for controlling temperature includes a cooler for said injection die located towards a downstream end of said injection die.

8. A multistage molding apparatus for continuously forming a composite article as claimed in claim 1 wherein said second stage includes a pultrusion die, downstream of said first stage, to cure said skin forming material and said resin to form said skin.

9. A multistage molding apparatus for continuously forming a composite article as claimed in claim 8 wherein said pultrusion die defines an internal surface, and said pultrusion die comprises a vacuum means to hold said skin forming material and said resin or said skin against said surface.

10. A multistage molding apparatus for continuously forming a composite article as claimed in claim 8 wherein said pultrusion die includes a means for thermally isolating said pultrusion die from said first stage, wherein said pultrusion die can be maintained at a different temperature than said first stage.

11. A multistage molding apparatus for continuously forming a composite article as claimed in claim 8 wherein said first stage comprises an injection die and a spaced apart mandrel to define an injection die cavity therebetween and wherein said pultrusion die further includes a pultrusion die cavity, said pultrusion die cavity being sized and shaped to match said injection die cavity.

12. A multistage molding apparatus for continuously forming a composite article as claimed in claim 11 wherein said mandrel for said injection die extends at least part way into said pultrusion die cavity.

13. A multistage molding apparatus for continuously forming a composite article as claimed in claim 12 further including a foam injector, positioned in said pultrusion die to apply foam to said skin forming material as said skin forming material is curing.

14. A multistage molding apparatus for continuously forming a composite article as claimed in claim 13 wherein said injection die is configured to form said skin forming material into a hollow member, and said foam injector places said foam inside of said hollow member.

15. A multistage molding apparatus for continuously forming a composite article as claimed in claim 14 wherein said foam injector is located on said mandrel and said mandrel further includes a foam delivery conduit connected to said foam injector.

16. A multistage molding apparatus for continuously forming a composite article as claimed in claim 1 further including means for preparing foam for application to said skin forming material.

17. A multistage molding apparatus for continuously forming a composite article as claimed in claim 16 wherein said means for preparing foam includes a foamer, a temperature and pressure controlled reservoir and a foam pump.

18. A multistage molding apparatus for continuously forming a composite article as claimed in claim 17 wherein said foamer has a first mixing chamber with an agitator and an air injection means, wherein a thermoplastic material can be melted and mixed to entrain air in the thermoplastic material under pressure.

19. A multistage molding apparatus for continuously forming a composite article as claimed in claim 18 wherein said foamer further includes a second mixing chamber having a mixer and a temperature control, to permit said thermoplastic material to be further mixed and cooled under pressure, said second chamber having an outlet for expelling said thermoplastic material from said chamber at a lower pressure than is maintained in said chamber into said reservoir.

20. A multistage molding apparatus for continuously forming a composite article as claimed in claim 19 further including a foam delivery conduit connected to said foam pump for permitting said foam to be delivered to said second stage from said reservoir.

21. A multistage molding apparatus for continuously forming a composite article as claimed in claim 17 wherein said foam pump comprises a piston or screw type pump.

22. A multistage molding apparatus for continuously forming a composite article as claimed in claim 1 wherein said third stage includes a curing die to complete the curing of said foam and skin composite article.

23. A multistage molding apparatus for continuously forming a composite article as claimed in claim 22 wherein said curing die is thermally isolated from said second stage to permit controlled curing of said composite article.

24. A multistage molding apparatus for continuously forming a composite article as claimed in claim 23 wherein said curing die is temperature controlled to permit adequate curing of said composite article.

25. A multistage molding apparatus for continuously forming a composite article as claimed in claim 1 further including a fourth stage for applying a coating to an outside surface of said composite article.

26. A multistage molding apparatus for continuously forming a composite article as claimed in claim 25 wherein said fourth stage includes a coating applicator for smoothly coating said composite article with said coating.

27. A multistage molding apparatus for continuously forming a composite article as claimed in claim 26 wherein said coating applicator applies a photo-curing coating and said fourth stage further includes a light source for curing said coating.

28. A multistage method for continuously forming a composite article, said method comprising the steps of:
impregnating a skin forming material with a resin at a first stage;
curing said impregnate skin forming material to form a skin, while applying a foam to said impregnated skin forming material before said impregnated skin forming material is fully cured in a second stage; and
curing said foamed skin to form said composite article at a third stage.

29. A multistage method for continuously forming a composite article, as claimed in claim 28, said method comprising using a sufficient amount of the same material in each of said resin and said foam to permit said foam to bond to said impregnated skin forming material, as said impregnated skin forming material is curing.

30. A multistage method for continuously forming a composite article, as claimed in claim 29 wherein said material is a type of thermoplastic resin.

31. A multistage method for continuously forming a composite article, as claimed in claim 28 wherein said first resin is made from a first composition and said foam is made from a second composition, wherein said first and second compositions have a sufficient amount of a common ingredient to permit said first and second compositions to bond to one another.

32. A multistage method for continuously forming a composite article, as claimed in claim 31 wherein said common ingredient is a type of thermoplastic resin.

33. A multistage method for continuously forming a composite article, as claimed in claim 32 wherein said thermoplastic resin is ABS plastic.

34. A multistage method for continuously forming a composite article, as claimed in claim 31 wherein said common ingredient is present in both of said first and second compositions in an amount of between about three percent and about seven percent by weight.

35. A multistage method for continuously forming a composite article, as claimed in claim 31 wherein said common ingredient is present in both of said first and second compositions in an amount of seven percent by weight or more.

36. A multistage method for continuously forming a composite article, as claimed in claim 29 wherein said method further comprises selecting a skin forming material having fibrous strands having one of a melting and a decomposition point above that of said resin used for impregnation of said skin forming material.

37. A multistage method for continuously forming a composite article, as claimed in claim 28 wherein said step of impregnating said skin forming material occurs at a first temperature, sufficient to melt and apply the resin to said skin forming material; said step of curing said impregnated skin forming material occurs at a second temperature capable of curing said skin forming material to form a skin, and said step of curing said composite article occurs at a third temperature suitable for curing said foam.

38. A multistage method for continuously forming a composite article, as claimed in claim 28 including a step of forming said foam under pressure, and reducing a pressure on said foam as said foam is applied to said impregnated skin forming material to permit said foam to expand onto said skin forming material.

39. A multistage method for continuously forming a composite article, as claimed in claim 32 wherein said impregnated skin forming material is formed into a hollow member and said foam is injected into an inside of said hollow member.

40. A multistage method for continuously forming a composite article, as claimed in claim 39 wherein said foam expands enough to fill said hollow member with said foam.

41. A multistage method for continuously forming a composite article, as claimed in claim 28 further including the step of using a mandrel to form said hollow member from said skin forming material and to deliver said foam to said inside of said hollow member as said impregnated skin forming material is curing.

42. A multistage method for continuously forming a composite article, as claimed in claim 28 further including a step of coating said composite article with a finish coat.

43. A multistage method for continuously forming a composite article, as claimed in claim 42 wherein said finish coat is applied after said third stage.

44. A multistage method for continuously forming a composite article, as claimed in claim 43 wherein said step of coating said composite article includes using a photocuring finish coating material.

45. A multistage method for continuously forming a composite article, as claimed in claim 44 wherein said photocuring finish coating material is cured by the application of UV energy.

46. A composite article comprising,
a skin layer bonded to a foam layer,
wherein said skin layer is made from a first composition and said foam layer is made from a second composition, and wherein said first and second compositions have a sufficient amount of a common ingredient to permit said first and second compositions to bond to one another.

47. A composite article as claimed in claim 46, wherein said first composition comprises a type of thermoset plastic and said second composition comprises a type of thermoplastic.

48. A composite article as claimed in claim 46, wherein said common ingredient is a type of thermoplastic.

49. A composite article as claimed in claim 48, wherein said thermoplastic is ABS plastic.

50. A composite article as claimed in claim 48, wherein said common ingredient is present in both of said first and second compositions in an amount of about seven percent by weight or more.

51. A composite article as claimed in claim 48, wherein said common ingredient is present in both of said first and second compositions in an amount of between about three percent and seven percent by weight.

52. A composite article as claimed in claim 46, further comprising a finish coat layer bonded to said skin layer.

53. A composite article as claimed in claim 52, wherein said finish coat layer is a type of photocured finish coat material.

54. A method of coating a pultruded article comprising the steps of: applying a coat of resin to an outside of the pultruded article; smoothing said coat of resin; and photocuring said smoothed coat.

55. A method as claimed in claim 54, wherein said method is carried out at a downstream end of a pultrusion machine.

56. A method as claimed in claim 55, wherein said method is a continuous process.

57. A device for continuously applying a coating to an outside surface of a pultruded article, the device including:
a source of liquid coating material; and
a coating applicator die, said coating applicator die having
a coating dispenser for applying said coating to said pultruded article, said dispenser being in fluid communication with said source of liquid coating material, and
a light source positioned downstream of said coating dispenser for curing said coating.

58. A device as claimed in claim 57, wherein said coating dispenser has a smoother to smooth the coating before said coating is cured by the light source.

59. A device as claimed in claim 57, further including a pump to apply said coating under pressure to said pultruded article through said coating dispenser.

60. A device as claimed in claim 58, wherein said smoother comprises a curved surface within said coating applicator die.

61. A device as claimed in claim 57, further including a means for drawing said pultruded article through said coating applicator die.

62. A device as claimed in claim 57, wherein said light source is a source of UV light.

63. A device as claimed in claim 57, wherein said coating applicator die is temperature controlled.

64. A device as claimed in claim 63, wherein said coating applicator die includes a cooler.

65. A device as claimed in claim 57, wherein said coating applicator die includes at least one thermal break.
